(19) United States
(12) Patent Application Publication
(10) Pub. No.: US 2024/0157251 A1
(43) Pub. Date: May 16, 2024

(54) COMPUTER-READABLE NON-TRANSITORY STORAGE MEDIUM HAVING INFORMATION PROCESSING PROGRAM STORED THEREIN, INFORMATION PROCESSING SYSTEM, INFORMATION PROCESSING APPARATUS, AND INFORMATION PROCESSING METHOD

(71) Applicant: NINTENDO CO., LTD., Kyoto (JP)

(72) Inventors: Shintaro SATO, Kyoto (JP); Yuichiro ITO, Kyoto (JP)

(21) Appl. No.: 18/502,467

(22) Filed: Nov. 6, 2023

(30) Foreign Application Priority Data
Nov. 11, 2022 (JP) 2022-181379

(51) Int. Cl. A63F 13/79; A63F 13/48; A63F 13/87

(52) U.S. Cl. CPC A63F 13/79; A63F 13/48; A63F 13/87

(57) ABSTRACT

According to the exemplary embodiment, a first name of a player is presented to other players in a first game, and before participating in a session for a second game, a player sets a second name and the second name is presented to other players in the second game.

### CROSS REFERENCE TO RELATED APPLICATION

This application claims priority to Japanese Patent Application No. 2022-181379 filed on Nov. 11, 2022, the entire contents of which are incorporated herein by reference.

### FIELD

The present disclosure relates to information processing of a game or the like.

### BACKGROUND AND SUMMARY

Conventionally, among competitive games in which game apparatuses connected via a network communicate with each other, there has been known a game in which a player name corresponding to a player is displayed.

In such a game in which a plurality of players participate as described above, there is a case where a player wants to change his/her player name to be displayed on an apparatus of another player in accordance with the type of a game in which the player participates. In this regard, there is room for improvement in the changing method.

The exemplary embodiments disclose an information processing program, an information processing system, an information processing apparatus, and an information processing method that make it possible to appropriately change the own player name to be displayed on an apparatus of another player in accordance with the kind of a game in which the player participates.

Configuration examples for achieving the above object will be shown below.

One configuration example is one or more non-transitory computer-readable storage media having stored therein instructions that, when executed by one or more processors of an information processing apparatus of a predetermined player among a plurality of information processing apparatuses connectable to a network and corresponding to a plurality of players, cause the information processing apparatus to: set a first name in association with the predetermined player; cause the predetermined player to participate in a first session on the basis of a first operation by the predetermined player, without letting the predetermined player select a session to participate in; when the predetermined player has participated in the first session, transmit first data including the first name to be presented as a name of the predetermined player, so as to be received by a computer of the information processing apparatus of another player, and execute a first game among the players who have participated in the first session; cause the predetermined player to participate in a second session on the basis of a second operation by the predetermined player different from the first operation; before causing the predetermined player to participate in the second session, accept an input of a second name from the predetermined player, and when the second name is inputted, set the second name in association with the predetermined player; and when the predetermined player has participated in the second session, transmit second data including either of the first name and the second name to be presented as a name of the predetermined player, so as to be received by the computer of the information processing apparatus of the other player, and execute a second game among the players who have participated in the second session.

According to the above configuration example, in a game in which the player can select a session to participate in, the player can set the second name (other name) before participating in the session. Thus, the player can set a player name to be displayed for other players, in accordance with the content of the session to participate in and other players who participate in the session.

In another configuration example, the second operation may include a third operation of creating the second session, and the instructions may cause the information processing apparatus to create the second session after making a setting so as to allow only the player satisfying a predetermined condition to participate in the second session on the basis of the third operation.

According to the above configuration example, only players satisfying a predetermined condition can participate in the second session. Thus, the player can set the second name (other name) in accordance with the predetermined condition.

In another configuration example, the predetermined condition may be a condition of being the player who has created the second session or the player who is in a friend relationship with the player who participates in the second session.

According to the above configuration example, the players who participate in the second session are directly or indirectly in a friend relationship with each other. Thus, each player can be identified even if he or she is an unfamiliar player.

In another configuration example, the second operation may include a fourth operation of participating in the second session created by the other player, and the instructions may cause the information processing apparatus to, before causing the player to participate in the second session on the basis of the fourth operation, present at least one of the first names associated with the players who participate in the second session.

According to the above configuration example, the first names (normal names) of other players who participate in the second session are presented. Thus, the player can easily know who participates in the second session, before participating in the second session.

In another configuration example, the instructions may cause the information processing apparatus to restrict change of the first name in a predetermined period after the first name has been set for the predetermined player.

According to the above configuration example, the frequency at which the first name (normal name) is changed is reduced. Thus, it is less likely to be difficult for the player to know who participates in the second session, before the player participates in the second session.

In another configuration example, the instructions may cause the information processing apparatus to present the first name or the second name of each player who has participated in the second session, and make a name presentation manner in which the first name is presented and a name presentation manner in which the second name is presented, different from each other.

According to the above configuration example, whether the displayed name is the first name (normal name) or the second name (other name) can be easily distinguished.

In another configuration example, the instructions may cause the information processing apparatus to set the second name at a timing when the second operation is performed.

According to the above configuration example, the second name (other name) is set at a timing when an operation of participating in the second session is performed. Thus, the other name can be presented in the second session.

In another configuration example, the instructions may cause the information processing apparatus to record the players who have participated in the second session, and store the first name or the second name presented during execution of the second session, in association with each player who has participated in the second session.

According to the above configuration example, it is possible to display the names of the players used when the second session was executed, when watching a record of the second session.

According to the exemplary embodiment, it is possible to provide a computer-readable non-transitory storage medium having an information processing program stored therein, an information processing system, an information processing apparatus, and an information processing method that make it possible to appropriately change the own player name to be displayed on an apparatus of another player in accordance with the kind of a game in which the player participates.

These and other objects, features, aspects, and effects of the exemplary embodiment will become more apparent from the following detailed description when taken in conjunction with the accompanying drawings.

### BRIEF DESCRIPTION OF THE DRAWINGS

FIG. 1 shows a non-limiting example of a state in which a left controller 3 and a right controller 4 are attached to a main body apparatus 2;

FIG. 2 shows a non-limiting example of a state in which the left controller 3 and the right controller 4 are detached from the main body apparatus 2;

FIG. 3 is six orthogonal views showing a non-limiting example of the main body apparatus 2;

FIG. 4 is six orthogonal views showing a non-limiting example of the left controller 3;

FIG. 5 is six orthogonal views showing a non-limiting example of the right controller 4;

FIG. 6 is a block diagram showing a non-limiting example of the internal configuration of the main body apparatus 2;

FIG. 7 is a block diagram showing a non-limiting example of the internal configurations of the main body apparatus 2, the left controller 3, and the right controller 4;

FIG. 8 illustrates a non-limiting example of menu display;

FIG. 9 illustrates a non-limiting example of participant member display for a normal battle;

FIG. 10 illustrates a non-limiting example of game display for a normal battle;

FIG. 11 illustrates a non-limiting example of display before participation in a private battle;

FIG. 12 illustrates a non-limiting example of display in a case of creating and participating in a private battle;

FIG. 13 illustrates a non-limiting example of display in a case of joining up to participate in a private battle;

FIG. 14 illustrates a non-limiting example of participant member display for a private battle;

FIG. 15 illustrates a non-limiting example of game display for a private battle;

FIG. 16 illustrates a non-limiting example of various data stored in a DRAM 85;

FIG. 17 illustrates a non-limiting example of a flowchart of game processing;

FIG. 18 illustrates a non-limiting example of a flowchart of the game processing;

FIG. 19 illustrates a non-limiting example of a flowchart of the game processing;

FIG. 20 illustrates a non-limiting example of a flowchart of the game processing; and

FIG. 21 illustrates a non-limiting example of a flowchart of the game processing.

### DETAILED DESCRIPTION OF NON-LIMITING EXAMPLE EMBODIMENTS

Hereinafter, an exemplary embodiment will be described.

[Hardware Configuration of Information Processing System]

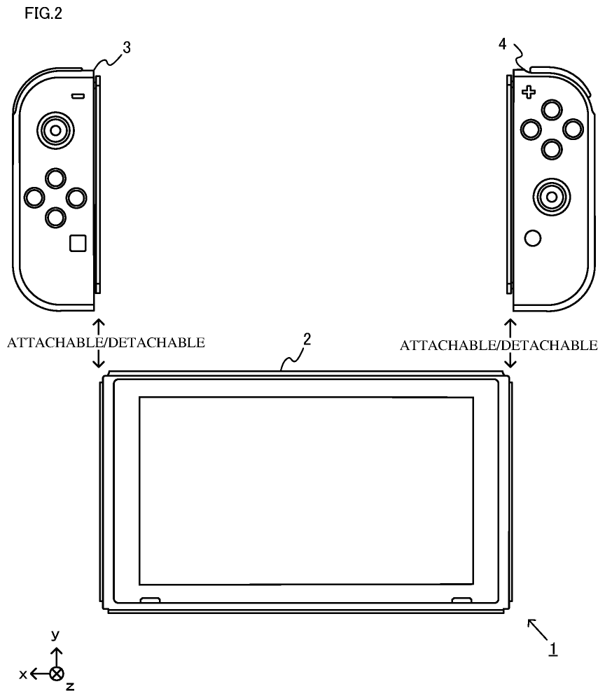

Hereinafter, an information processing system (game system) according to an example of the exemplary embodiment will be described below. An example of a game system 1 according to the exemplary embodiment includes a main body apparatus (an information processing apparatus, which functions as a game apparatus main body in the exemplary embodiment) 2, a left controller 3, and a right controller 4. Each of the left controller 3 and the right controller 4 is attachable to and detachable from the main body apparatus 2. That is, the game system 1 can be used as a unified apparatus obtained by attaching each of the left controller 3 and the right controller 4 to the main body apparatus 2. Further, in the game system 1, the main body apparatus 2, the left controller 3, and the right controller 4 can also be used as separate bodies (see FIG. 2). Hereinafter, first, the hardware configuration of the game system 1 according to the exemplary embodiment will be described, and then, the control of the game system 1 according to the exemplary embodiment will be described.

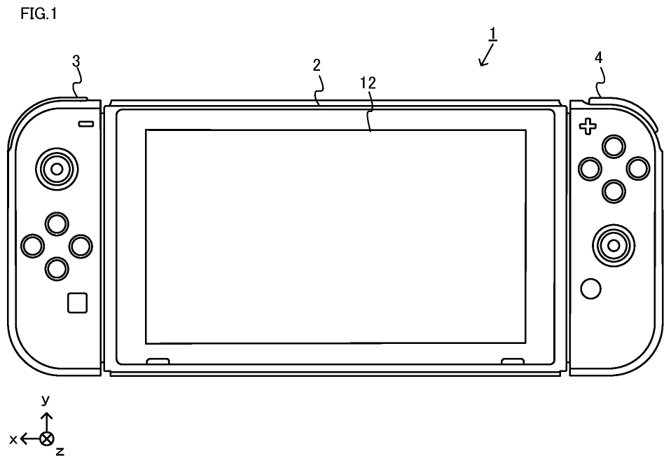

FIG. 1 shows an example of the state where the left controller 3 and the right controller 4 are attached to the main body apparatus 2. As shown in FIG. 1, each of the left controller 3 and the right controller 4 is attached to and unified with the main body apparatus 2. The main body apparatus 2 is an apparatus for performing various processes (e.g., game processing) in the game system 1. The main body apparatus 2 includes a display 12. Each of the left controller 3 and the right controller 4 is an apparatus including operation sections with which a user provides inputs.

FIG. 2 shows an example of the state where each of the left controller 3 and the right controller 4 is detached from the main body apparatus 2. As shown in FIGS. 1 and 2, the left controller 3 and the right controller 4 are attachable to and detachable from the main body apparatus 2. Hereinafter, the left controller 3 and the right controller 4 may be collectively referred to as “controller”.

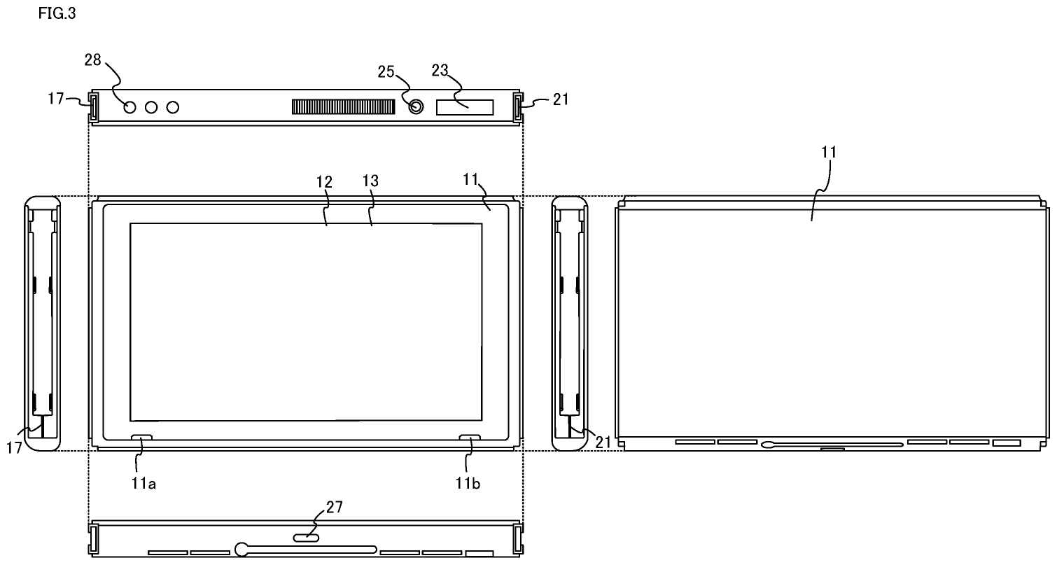

FIG. 3 is six orthogonal views showing an example of the main body apparatus 2. As shown in FIG. 3, the main body apparatus 2 includes an approximately plate-shaped housing 11. In the exemplary embodiment, a main surface (in other words, a surface on a front side, i.e., a surface on which the display 12 is provided) of the housing 11 has a substantially rectangular shape.

The shape and the size of the housing 11 are discretionary. As an example, the housing 11 may be of a portable size. Further, the main body apparatus 2 alone or the unified apparatus obtained by attaching the left controller 3 and the right controller 4 to the main body apparatus 2 may function as a mobile apparatus. The main body apparatus 2 or the unified apparatus may function as a handheld apparatus or a portable apparatus.

As shown in FIG. 3, the main body apparatus 2 includes the display 12, which is provided on the main surface of the housing 11. The display 12 displays an image generated by the main body apparatus 2. In the exemplary embodiment, the display 12 is a liquid crystal display device (LCD). The display 12, however, may be a display device of any type.

The main body apparatus 2 includes a touch panel 13 on the screen of the display 12. In the exemplary embodiment, the touch panel 13 is of a type capable of receiving a multi-touch input (e.g., electrical capacitance type). However, the touch panel 13 may be of any type, and may be, for example, of a type capable of receiving a single-touch input (e.g., resistive film type).

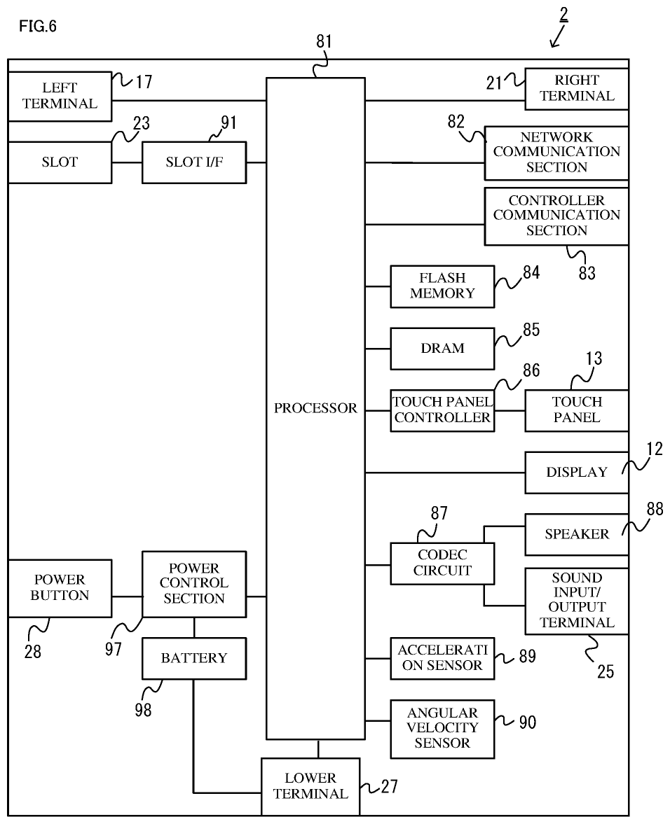

The main body apparatus 2 includes speakers (i.e., speakers 88 shown in FIG. 6) within the housing 11. As shown in FIG. 3, speaker holes 11a and 11b are formed in the main surface of the housing 11. Then, sounds outputted from the speakers 88 are outputted through the speaker holes 11a and 11b.

Further, the main body apparatus 2 includes a left terminal 17, which is a terminal for the main body apparatus 2 to perform wired communication with the left controller 3, and a right terminal 21, which is a terminal for the main body apparatus 2 to perform wired communication with the right controller 4.

As shown in FIG. 3, the main body apparatus 2 includes a slot 23. The slot 23 is provided at an upper side surface of the housing 11. The slot 23 is so shaped as to allow a predetermined type of storage medium to be attached to the slot 23. The predetermined type of storage medium is, for example, a dedicated storage medium (e.g., a dedicated memory card) for the game system 1 and an information processing apparatus of the same type as the game system 1. The predetermined type of storage medium is used to store, for example, data (e.g., saved data of an application or the like) used by the main body apparatus 2 and/or a program (e.g., a program for an application or the like) executed by the main body apparatus 2. Further, the main body apparatus 2 includes a power button 28.

The main body apparatus 2 includes a lower terminal 27. The lower terminal 27 is a terminal for the main body apparatus 2 to communicate with a cradle. In the exemplary embodiment, the lower terminal 27 is a USB connector (more specifically, a female connector). Further, when the unified apparatus or the main body apparatus 2 alone is mounted on the cradle, the game system 1 can display on a stationary monitor an image generated by and outputted from the main body apparatus 2. Further, in the exemplary embodiment, the cradle has the function of charging the unified apparatus or the main body apparatus 2 alone mounted on the cradle. Further, the cradle has the function of a hub device (specifically, a USB hub).

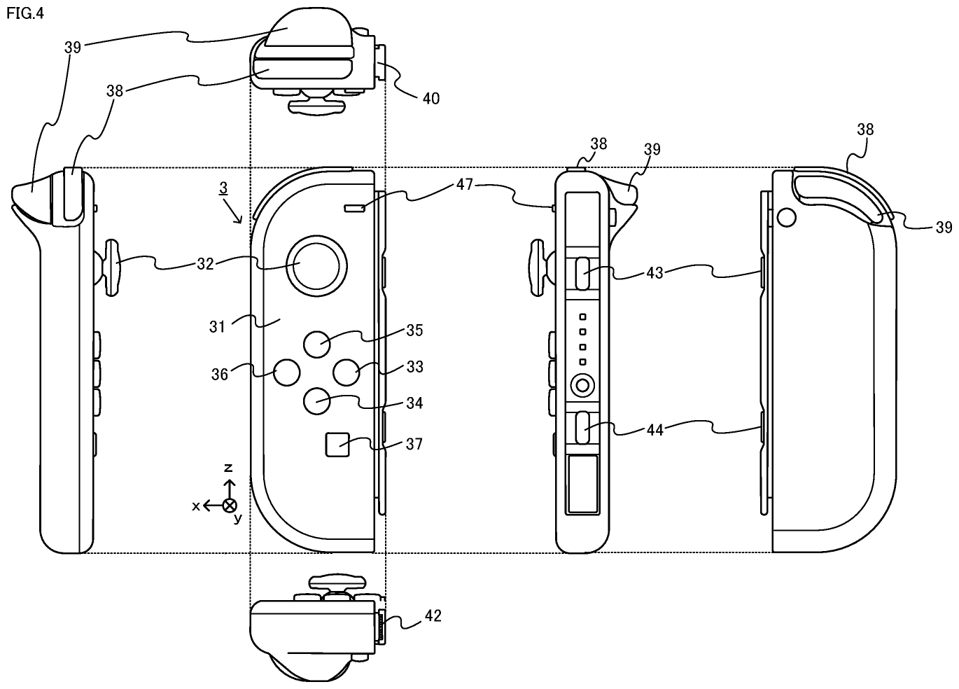

FIG. 4 is six orthogonal views showing an example of the left controller 3. As shown in FIG. 4, the left controller 3 includes a housing 31. In the exemplary embodiment, the housing 31 has a vertically long shape, i.e., is shaped to be long in an up-down direction shown in FIG. 4 (i.e., a z-axis direction shown in FIG. 4). In the state where the left controller 3 is detached from the main body apparatus 2, the left controller 3 can also be held in the orientation in which the left controller 3 is vertically long. The housing 31 has such a shape and a size that when held in the orientation in which the housing 31 is vertically long, the housing 31 can be held with one hand, particularly, the left hand. Further, the left controller 3 can also be held in the orientation in which the left controller 3 is horizontally long. When held in the orientation in which the left controller 3 is horizontally long, the left controller 3 may be held with both hands.

The left controller 3 includes a left analog stick (hereinafter, referred to as a “left stick”) 32 as an example of a direction input device. As shown in FIG. 4, the left stick 32 is provided on a main surface of the housing 31. The left stick 32 can be used as a direction input section with which a direction can be inputted. The user tilts the left stick 32 and thereby can input a direction corresponding to the direction of the tilt (and input a magnitude corresponding to the angle of the tilt). The left controller 3 may include a directional pad, a slide stick that allows a slide input, or the like as the direction input section, instead of the analog stick. Further, in the exemplary embodiment, it is possible to provide an input by pressing the left stick 32.

The left controller 3 includes various operation buttons. The left controller 3 includes four operation buttons 33 to 36 (specifically, a right direction button 33, a down direction button 34, an up direction button 35, and a left direction button 36) on the main surface of the housing 31. Further, the left controller 3 includes a record button 37 and a “−” (minus) button 47. The left controller 3 includes a first L-button 38 and a ZL-button 39 in an upper left portion of a side surface of the housing 31. Further, the left controller 3 includes a second L-button 43 and a second R-button 44, on the side surface of the housing 31 on which the left controller 3 is attached to the main body apparatus 2. These operation buttons are used to give instructions depending on various programs (e.g., an OS program and an application program) executed by the main body apparatus 2.

Further, the left controller 3 includes a terminal 42 for the left controller 3 to perform wired communication with the main body apparatus 2.

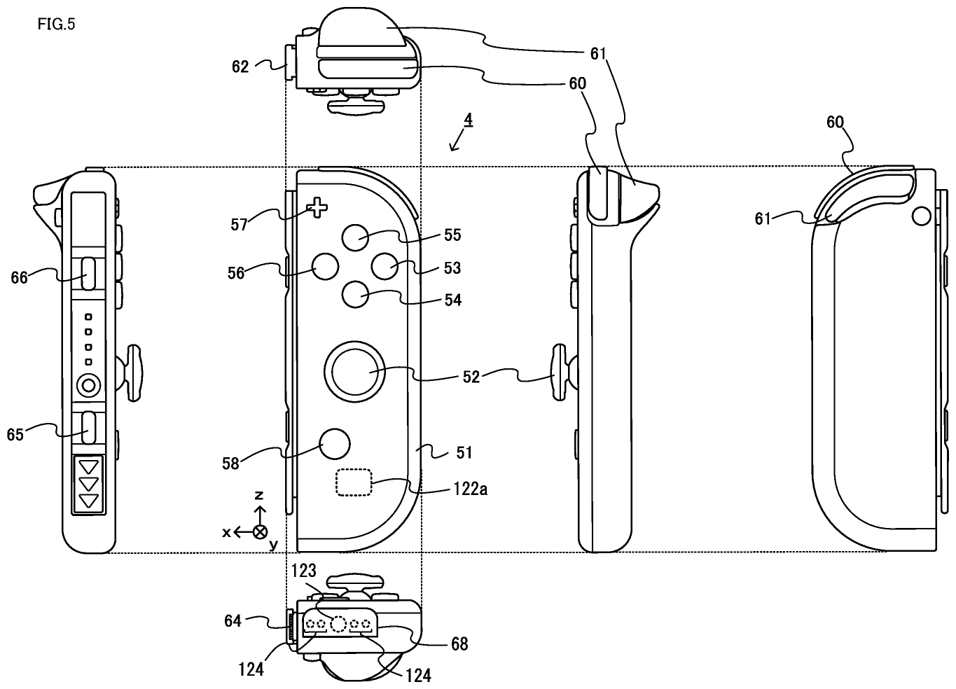

FIG. 5 is six orthogonal views showing an example of the right controller 4. As shown in FIG. 5, the right controller 4 includes a housing 51. In the exemplary embodiment, the housing 51 has a vertically long shape, i.e., is shaped to be long in the up-down direction shown in FIG. 5 (i.e., the z-axis direction shown in FIG. 5). In the state where the right controller 4 is detached from the main body apparatus 2, the right controller 4 can also be held in the orientation in which the right controller 4 is vertically long. The housing 51 has such a shape and a size that when held in the orientation in which the housing 51 is vertically long, the housing 51 can be held with one hand, particularly the right hand. Further, the right controller 4 can also be held in the orientation in which the right controller 4 is horizontally long. When held in the orientation in which the right controller 4 is horizontally long, the right controller 4 may be held with both hands.

Similarly to the left controller 3, the right controller 4 includes a right analog stick (hereinafter, referred to as a “right stick”) 52 as a direction input section. In the exemplary embodiment, the right stick 52 has the same configuration as that of the left stick 32 of the left controller 3. Further, the right controller 4 may include a directional pad, a slide stick that allows a slide input, or the like, instead of the analog stick. Further, similarly to the left controller 3, the right controller 4 includes four operation buttons 53 to 56 (specifically, an A-button 53, a B-button 54, an X-button 55, and a Y-button 56) on a main surface of the housing 51. Further, the right controller 4 includes a “+” (plus) button 57 and a home button 58. Further, the right controller 4 includes a first R-button 60 and a ZR-button 61 in an upper right portion of a side surface of the housing 51. Further, similarly to the left controller 3, the right controller 4 includes a second L-button 65 and a second R-button 66.

Further, the right controller 4 includes a terminal 64 for the right controller 4 to perform wired communication with the main body apparatus 2.

FIG. 6 is a block diagram showing an example of the internal configuration of the main body apparatus 2. The main body apparatus 2 includes components 81 to 91, 97, and 98 shown in FIG. 6 in addition to the components shown in FIG. 3. Some of the components 81 to 91, 97, and 98 may be mounted as electronic components on an electronic circuit board and housed in the housing 11.

The main body apparatus 2 includes a processor 81. The processor 81 is an information processing section for executing various types of information processing to be executed by the main body apparatus 2. For example, the processor 81 may be composed only of a CPU (Central Processing Unit), or may be composed of a SoC (System-on-a-chip) having a plurality of functions such as a CPU function and a GPU (Graphics Processing Unit) function. The processor 81 executes an information processing program (e.g., a game program) stored in a storage section (specifically, an internal storage medium such as a flash memory 84, an external storage medium attached to the slot 23, or the like), thereby performing the various types of information processing. The main body apparatus 2 may include a plurality of processors, and information processing may be executed by the plurality of processors in a shared manner.

The main body apparatus 2 includes the flash memory 84 and a DRAM (Dynamic Random Access Memory) 85 as examples of internal storage media built into the main body apparatus 2. The flash memory 84 and the DRAM 85 are connected to the processor 81. The flash memory 84 is a memory mainly used to store various data (or programs) to be saved in the main body apparatus 2. The DRAM 85 is a memory used to temporarily store various data used for information processing. The main body apparatus 2 may include a plurality of internal storage media (such as flash memories), and data in the plurality of internal storage media (and external storage media, etc.,) may be used for information processing.

The main body apparatus 2 includes a slot interface (hereinafter, abbreviated as “I/F”) 91. The slot I/F 91 is connected to the processor 81. The slot I/F 91 is connected to the slot 23, and in accordance with an instruction from the processor 81, reads and writes data from and to the predetermined type of storage medium (e.g., a dedicated memory card) attached to the slot 23.

The processor 81 appropriately reads and writes data from and to the flash memory 84, the DRAM 85, and each of the above storage media, thereby performing the above information processing.

The main body apparatus 2 includes a network communication section 82. The network communication section 82 is connected to the processor 81. The network communication section 82 communicates (specifically, through wireless communication) with an external apparatus via a network. In the exemplary embodiment, the network communication section 82 connects to a wireless LAN by a method compliant with the Wi-Fi standard, for example, and performs Internet communication or the like with an external apparatus (another main body apparatus 2). Further, the network communication section 82 can also perform short-range wireless communication (e.g., infrared light communication) with another main body apparatus 2.

The main body apparatus 2 includes a controller communication section 83. The controller communication section 83 is connected to the processor 81. The controller communication section 83 wirelessly communicates with the left controller 3 and/or the right controller 4. The communication method between the main body apparatus 2, and the left controller 3 and the right controller 4, is discretionary. In the exemplary embodiment, the controller communication section 83 performs communication compliant with the Bluetooth (registered trademark) standard with the left controller 3 and with the right controller 4.

The processor 81 is connected to the left terminal 17, the right terminal 21, and the lower terminal 27. When performing wired communication with the left controller 3, the processor 81 transmits data to the left controller 3 via the left terminal 17 and also receives operation data from the left controller 3 via the left terminal 17. Further, when performing wired communication with the right controller 4, the processor 81 transmits data to the right controller 4 via the right terminal 21 and also receives operation data from the right controller 4 via the right terminal 21. Further, when communicating with the cradle, the processor 81 transmits data to the cradle via the lower terminal 27. As described above, in the exemplary embodiment, the main body apparatus 2 can perform both wired communication and wireless communication with each of the left controller 3 and the right controller 4. Further, when the unified apparatus obtained by attaching the left controller 3 and the right controller 4 to the main body apparatus 2 or the main body apparatus 2 alone is attached to the cradle, the main body apparatus 2 can output data (e.g., image data or sound data) to the stationary monitor or the like via the cradle.

Here, the main body apparatus 2 can communicate with a plurality of left controllers 3 simultaneously (in other words, in parallel). Further, the main body apparatus 2 can communicate with a plurality of right controllers 4 simultaneously (in other words, in parallel). Thus, a plurality of users can simultaneously provide inputs to the main body apparatus 2, each using a set of the left controller 3 and the right controller 4. As an example, a first user can provide an input to the main body apparatus 2 using a first set of the left controller 3 and the right controller 4, and simultaneously, a second user can provide an input to the main body apparatus 2 using a second set of the left controller 3 and the right controller 4.

The main body apparatus 2 includes a touch panel controller 86, which is a circuit for controlling the touch panel 13. The touch panel controller 86 is connected between the touch panel 13 and the processor 81. On the basis of a signal from the touch panel 13, the touch panel controller 86 generates data indicating the position at which a touch input has been performed, for example, and outputs the data to the processor 81.

Further, the display 12 is connected to the processor 81. The processor 81 displays a generated image (e.g., an image generated by executing the above information processing) and/or an externally acquired image on the display 12.

The main body apparatus 2 includes a codec circuit 87 and speakers (specifically, a left speaker and a right speaker) 88. The codec circuit 87 is connected to the speakers 88 and a sound input/output terminal 25 and also connected to the processor 81. The codec circuit 87 is a circuit for controlling the input and output of sound data to and from the speakers 88 and the sound input/output terminal 25.

The main body apparatus 2 includes a power control section 97 and a battery 98. The power control section 97 is connected to the battery 98 and the processor 81. Further, although not shown in FIG. 6, the power control section 97 is connected to components of the main body apparatus 2 (specifically, components that receive power supplied from the battery 98, the left terminal 17, and the right terminal 21). On the basis of a command from the processor 81, the power control section 97 controls the supply of power from the battery 98 to the above components.

Further, the battery 98 is connected to the lower terminal 27. When an external charging device (e.g., the cradle) is connected to the lower terminal 27 and power is supplied to the main body apparatus 2 via the lower terminal 27, the battery 98 is charged with the supplied power.

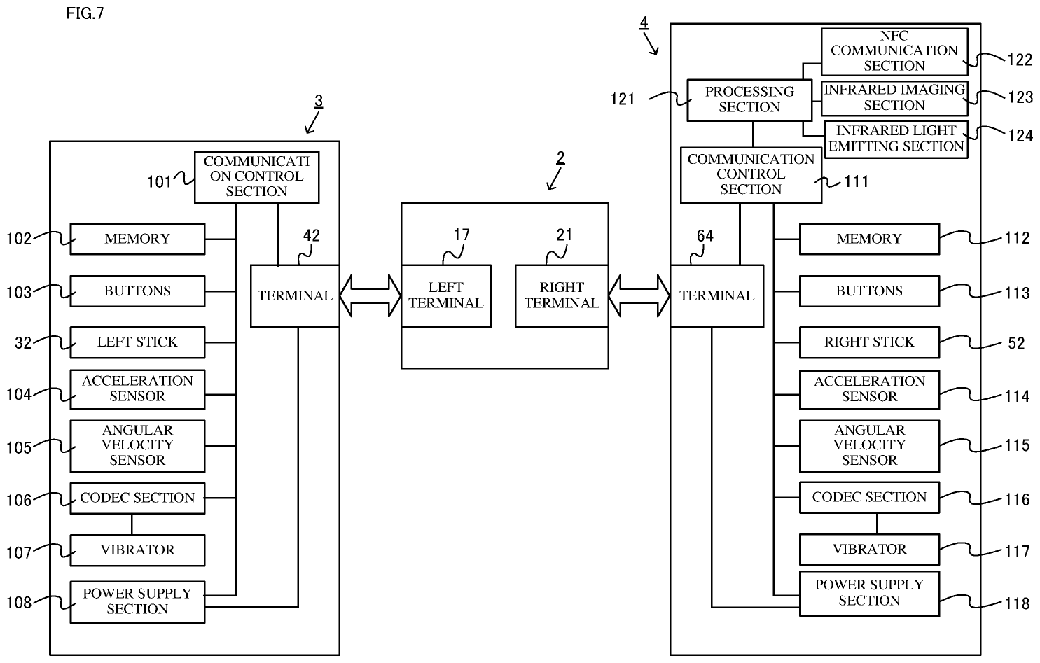

FIG. 7 is a block diagram showing examples of the internal configurations of the main body apparatus 2, the left controller 3, and the right controller 4. The details of the internal configuration of the main body apparatus 2 are shown in FIG. 6 and therefore are omitted in FIG. 7.

The left controller 3 includes a communication control section 101, which communicates with the main body apparatus 2. As shown in FIG. 7, the communication control section 101 is connected to components including the terminal 42. In the exemplary embodiment, the communication control section 101 can communicate with the main body apparatus 2 through both wired communication via the terminal 42 and wireless communication not via the terminal 42. The communication control section 101 controls the method for communication performed by the left controller 3 with the main body apparatus 2. That is, when the left controller 3 is attached to the main body apparatus 2, the communication control section 101 communicates with the main body apparatus 2 via the terminal 42. Further, when the left controller 3 is detached from the main body apparatus 2, the communication control section 101 wirelessly communicates with the main body apparatus 2 (specifically, the controller communication section 83). The wireless communication between the communication control section 101 and the controller communication section 83 is performed in accordance with the Bluetooth (registered trademark) standard, for example.

Further, the left controller 3 includes a memory 102 such as a flash memory. The communication control section 101 includes, for example, a microcomputer (or a microprocessor) and executes firmware stored in the memory 102, thereby performing various processes.

The left controller 3 includes buttons 103 (specifically, the buttons 33 to 39, 43, 44, and 47). Further, the left controller 3 includes the left stick 32. Each of the buttons 103 and the left stick 32 outputs information regarding an operation performed on itself to the communication control section 101 repeatedly at appropriate timings.

The left controller 3 includes inertial sensors. Specifically, the left controller 3 includes an acceleration sensor 104. Further, the left controller 3 includes an angular velocity sensor 105. In the exemplary embodiment, the acceleration sensor 104 detects the magnitudes of accelerations along predetermined three axial (e.g., x, y, z axes shown in FIG. 4) directions. The acceleration sensor 104 may detect an acceleration along one axial direction or accelerations along two axial directions. In the exemplary embodiment, the angular velocity sensor 105 detects angular velocities about predetermined three axes (e.g., the x, y, z axes shown in FIG. 4). The angular velocity sensor 105 may detect an angular velocity about one axis or angular velocities about two axes. Each of the acceleration sensor 104 and the angular velocity sensor 105 is connected to the communication control section 101. Then, the detection results of the acceleration sensor 104 and the angular velocity sensor 105 are outputted to the communication control section 101 repeatedly at appropriate timings.

The communication control section 101 acquires information regarding an input (specifically, information regarding an operation or the detection result of the sensor) from each of input sections (specifically, the buttons 103, the left stick 32, and the sensors 104 and 105). The communication control section 101 transmits operation data including the acquired information (or information obtained by performing predetermined processing on the acquired information) to the main body apparatus 2. The operation data is transmitted repeatedly, once every predetermined time. The interval at which the information regarding an input is transmitted from each of the input sections to the main body apparatus 2 may or may not be the same.

The above operation data is transmitted to the main body apparatus 2, whereby the main body apparatus 2 can obtain inputs provided to the left controller 3. That is, the main body apparatus 2 can determine operations on the buttons 103 and the left stick 32 on the basis of the operation data. Further, the main body apparatus 2 can calculate information regarding the motion and/or the orientation of the left controller 3 on the basis of the operation data (specifically, the detection results of the acceleration sensor 104 and the angular velocity sensor 105).

The left controller 3 includes a power supply section 108. In the exemplary embodiment, the power supply section 108 includes a battery and a power control circuit. Although not shown in FIG. 7, the power control circuit is connected to the battery and also connected to components of the left controller 3 (specifically, components that receive power supplied from the battery).

As shown in FIG. 7, the right controller 4 includes a communication control section 111, which communicates with the main body apparatus 2. Further, the right controller 4 includes a memory 112, which is connected to the communication control section 111. The communication control section 111 is connected to components including the terminal 64. The communication control section 111 and the memory 112 have functions similar to those of the communication control section 101 and the memory 102, respectively, of the left controller 3. Thus, the communication control section 111 can communicate with the main body apparatus 2 through both wired communication via the terminal 64 and wireless communication not via the terminal 64 (specifically, communication compliant with the Bluetooth (registered trademark) standard). The communication control section 111 controls the method for communication performed by the right controller 4 with the main body apparatus 2.

The right controller 4 includes input sections similar to the input sections of the left controller 3. Specifically, the right controller 4 includes buttons 113, the right stick 52, and inertial sensors (an acceleration sensor 114 and an angular velocity sensor 115). These input sections have functions similar to those of the input sections of the left controller 3 and operate similarly to the input sections of the left controller 3.

The right controller 4 includes a power supply section 118. The power supply section 118 has a function similar to that of the power supply section 108 of the left controller 3 and operates similarly to the power supply section 108.

[Outline of Game Processing in Exemplary Embodiment]

Next, the outline of operation of the game processing executed by the game system 1 (hereinafter, may be referred to as “game apparatus 1”) according to the exemplary embodiment will be described. As described above, in the game system 1, the main body apparatus 2 is configured such that each of the left controller 3 and the right controller 4 is attachable thereto and detachable therefrom. In a case of playing the game with the left controller 3 and the right controller 4 attached to the main body apparatus 2, a game image is outputted to the display 12. In a case where the main body apparatus 2 alone with the left controller 3 and the right controller 4 detached therefrom is mounted on the cradle, the main body apparatus 2 can output a game image to a stationary monitor or the like via the cradle. In the exemplary embodiment, the case of playing the game in the former manner will be described as an example.

[Game Assumed in Exemplary Embodiment]

Next, the outline of game processing (example of information processing) executed in the game system 1 according to the exemplary embodiment will be described. The game assumed in the exemplary embodiment is a battle game in which players not more than four versus four compete, as an example. Specifically, in this game, not more than eight character objects (may be referred to as “characters”) which are virtual human-type objects are placed in a battle stage prepared in a virtual space, and a team composed of not more than four characters and a team composed of the other not more than four characters compete with each other. In this game, as an example, it is assumed that each player creates the own player account (may be simply referred to as “account”) in advance and can play this game on any game apparatus 1 using the created own player account. Instead of such a configuration that each player is identified by an account associated with the player, each player may be identified by the game apparatus 1 associated with the player.

This game can be played by a plurality of players (users) via a network such as the Internet or through short-range wireless communication, etc. In the exemplary embodiment, it is assumed that one player performs operation in charge of one character.

[Outline of Game Processing in Exemplary Embodiment]

Next, the outline of the game processing executed by the game apparatus 1 according to the exemplary embodiment will be described. First, when an application of this game is started and the game processing is started, as shown in FIG. 8, a menu screen showing a menu is displayed. FIG. 8 shows an example of the menu display in this game.

As shown in FIG. 8, the menu display includes a menu 210 with an indication “set normal name”, a menu 211 with an indication “normal battle”, a menu 212 with an indication “private battle”, and a menu 213 with an indication “end application”. As shown in FIG. 8, a cursor 200 for selecting a menu is displayed. By performing a predetermined operation (such as button operation), the player can select a desired menu by the cursor 200 and determine execution of the menu. In the example shown in FIG. 8, the menu 210 is selected.

When the menu 210 executed by a player's operation, a screen (not shown) for inputting a normal name (player name; first name) of the player is displayed, and the player can input an arbitrary normal name within a predetermined number of letters (e.g., not more than ten letters). As described later, the normal name is displayed at a position, e.g., near a character (may be referred to as “own character”) that the player operates in this game. When the menu 211 is executed by a player's operation, the player is to participate in a normal battle (first game) in this game. As described later, the normal battle is a battle in which battle participants are automatically sorted by a server that can communicate with the game apparatuses 1 via the network. When the menu 212 is executed by a player's operation, the screen shifts to a screen where the player can participate in a private battle (second game) in this game. The private battle is a battle for which a predetermined participation condition is set, and as described later, only a player satisfying the predetermined participation condition can participate in the private battle. When the menu 213 is executed by a player's operation, the application of this game is ended and the processing of this game is ended.

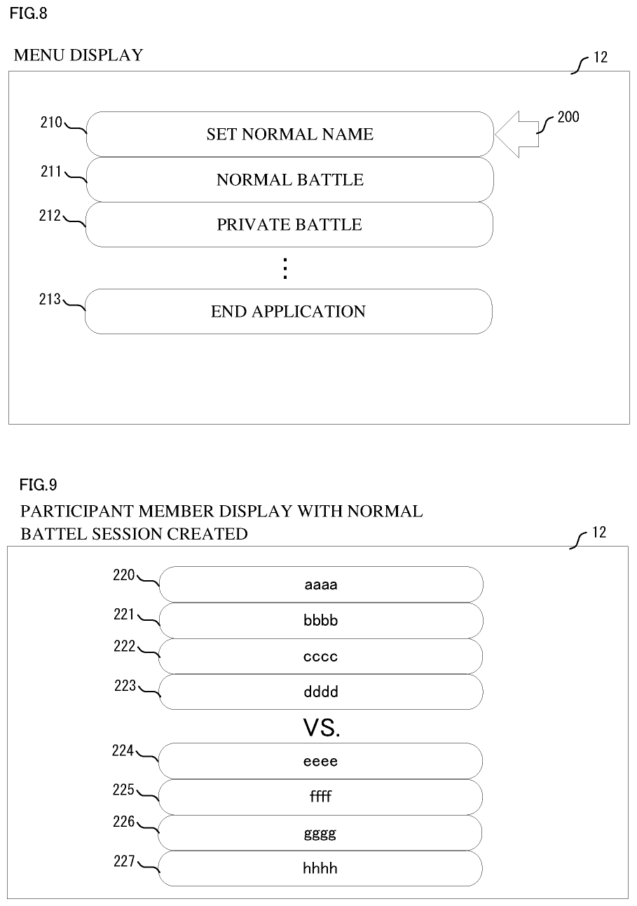

FIG. 9 shows a screen displayed when the menu 211 (see FIG. 8) with an indication “normal battle” is executed. When the menu 211 is executed by a player's operation, a server on the network creates a session where participant members for a normal battle are automatically sorted (matched) in consideration of the levels of characters operated by players, etc., and the sorted participant members are sequentially displayed, thus performing participant member standby display (not shown). Thereafter, as shown in FIG. 9, eight normal names indicating the automatically sorted (matched) participant members in the normal battle are displayed in a state of being automatically divided into two teams (four versus four) to compete with each other.

The session is a virtual area where members to participate in a battle are gathered to perform a normal battle or a private battle. The members participating in the session (game apparatuses that the participant players operate) can communicate with each other indirectly via the server or directly between the game apparatuses. The session may be considered to be a virtual room. In FIG. 9, “aaaa”, “bbbb”, “cccc”, and “dddd” are displayed as normal names of players composing one team (see reference characters 220 to 223), and “eeee”, “ffff”, “gggg”, and “hhhh” are displayed as normal names of players composing the other team (see reference characters 224 to 227). In the exemplary embodiment, for convenience of description, normal names are written by lowercase letters and other names described later are written by uppercase letters. However, in actuality, players can use arbitrary letters (various letters including lowercase letters and uppercase letters) for normal names and other names.

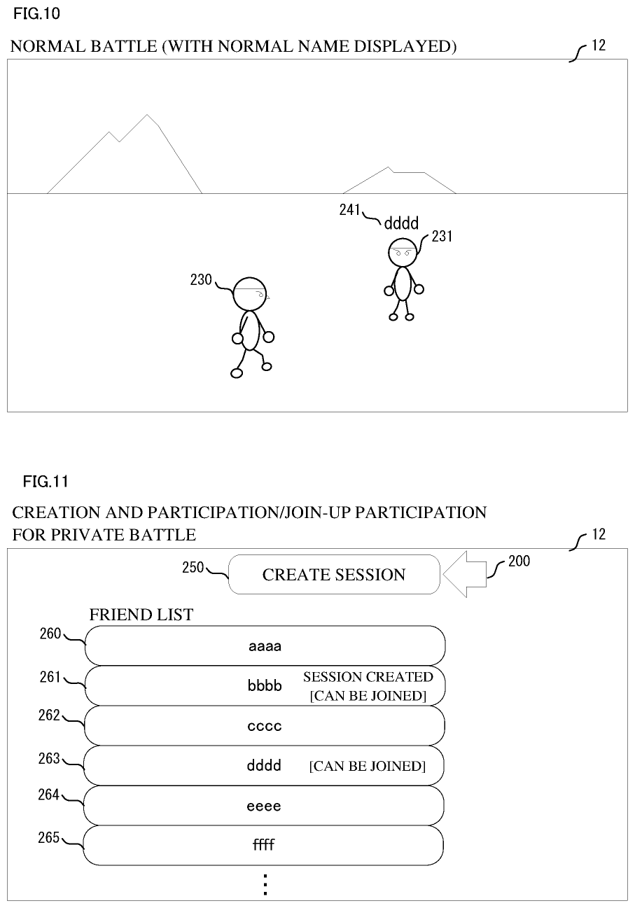

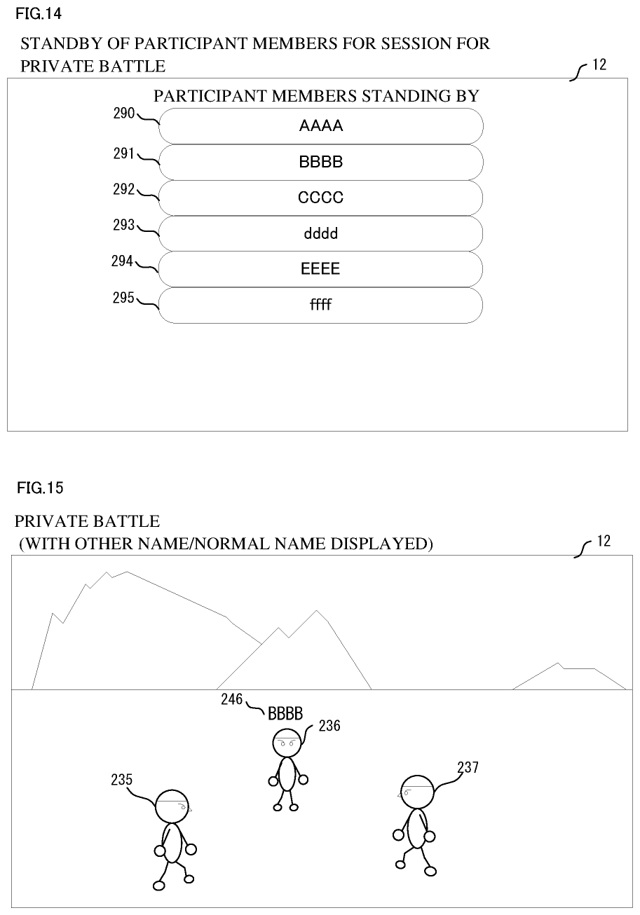

FIG. 10 shows an example of a screen of a normal battle. As shown in FIG. 10, in a virtual space (game space) where the normal battle is executed, characters of players are displayed, and above an ally character, the normal name of the player who operates the ally character is displayed. In the example shown in FIG. 10, an own character 230 and an ally character 231 are displayed, and a normal name “dddd” of the player who operates the ally character 231 is displayed above the ally character 231. A normal name may be displayed also for an enemy character, and a normal name may be displayed also for an own character. Not only virtual spaces in which participant members are displayed (see FIG. 9 and FIG. 14) but also a virtual space in which a normal battle is executed (see FIG. 10) and a virtual space in which a private battle described later is executed (see FIG. 15) may be considered to be included as sessions described above.

FIG. 11 shows a screen displayed when the menu 212 (see FIG. 8) with an indication “private battle” is executed. When the menu 212 is executed by a player's operation, a screen for participating in a private battle is displayed. Specifically, as shown in FIG. 11, a menu 250 described as “create session” and a player's friend list are displayed.

The friend list is a list on which the normal names of players who are friends of the player are displayed. In the exemplary embodiment, while the game processing is not being executed, if a friend request transmitted from one player (one player account) to another player (another player account) in advance is accepted by the other player, both players come into a friend relationship. The players in the friend relationship can each uniquely identify the counterpart player (account) by exchanging data of ID numbers, for example. Creation of a friend relationship may be allowed also during execution of the game processing. In the example shown in FIG. 11, on the friend list, an indication 260 of a normal name “aaaa”, an indication 261 of a normal name “bbbb”, an indication 262 of a normal name “cccc”, an indication 263 of a normal name “dddd”, an indication 264 of a normal name “eeee”, an indication 265 of a normal name “ffff”, and the like are displayed. As shown in FIG. 11, an indication “session created [can be joined]” is displayed on a side of the normal name of the friend (may be referred to as “host player”) who has created a session of a private battle, among the friends displayed on the friend list. In the example shown in FIG. 11, an indication “session created [can be joined]” is displayed at the indication 261 of the normal name “bbbb”. In addition, as shown in FIG. 11, an indication “[can be joined]” is displayed on a side of the normal name of the friend (player) who has joined up to participate in a session of a private battle, among the friends displayed on the friend list. In the example shown in FIG. 11, an indication “[can be joined]” is displayed at the indication 263 of the normal name “dddd”. The case of joining up to participate in the session will be described later. In FIG. 11, the friend (reference character 263) with an indication “[can be joined]” is a player who has participated in a session of a private battle but is not a host player for the session (in other words, a player who is directly or indirectly in a friend relationship with the host player for the private battle).

By performing a predetermined operation, the player can move the cursor 200, to select any of the menu 250 with an indication “create session”, the friend with an indication “session created [can be joined]”, and the friend with an indication “[can be joined]”, and execute the corresponding processing.

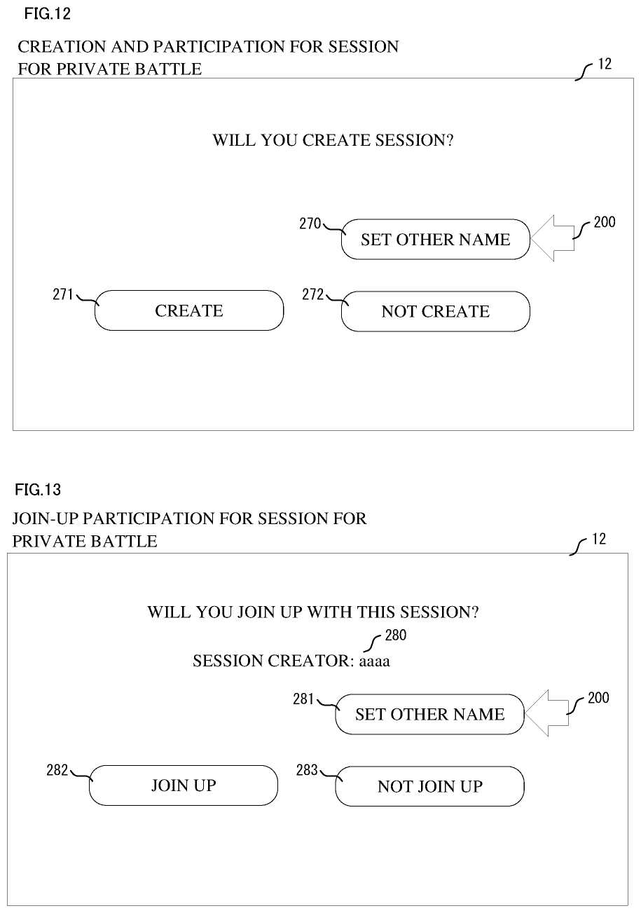

FIG. 12 shows a screen displayed when the menu 250 (see FIG. 11) with an indication “create session” is executed. When the menu 250 is executed by a player's operation, as shown in FIG. 12, a screen for the player to create a session for a private battle and participate in the session is displayed.

Specifically, as shown in FIG. 12, a phrase “Will you create session?”, a button 270 with an indication “set other name”, a button 271 with an indication “create”, and a button 272 with an indication “not create”, are displayed. When the player operates the cursor 200 and has selected and pressed the button 270 with an indication “set other name”, a screen (not shown) on which the player can set another name (second name) is displayed. The player performs an operation of inputting letters on the screen on which another name can be set, whereby the player can set an arbitrary other name within a predetermined number of letters (e.g., not more than ten letters). As described later, another name is a name displayed instead of the above normal name during execution of the private battle in which the player participates this time, etc. On the screen on which another name can be set, another name that was previously set may be displayed as an initial indication. When the player operates the cursor 200 and has selected and pressed the button 271 with an indication “create”, a session for a private battle is created. When the session for the private battle is created, a “session created [can be joined]” is displayed on a side of the corresponding normal name on the friend list of a player who is friends with the player (host player) who has created the session (see FIG. 11). When the player operates the cursor 200 and has selected and pressed the button 272 with an indication “not create”, a session for a private battle is not created and the screen returns to the screen shown in FIG. 11.

FIG. 13 shows a screen displayed when processing for the friend with an indication “session created [can be joined]” or “[can be joined]” is executed (see FIG. 11). In this case, as shown in FIG. 13, a screen for joining up to participate in a session for a private battle is displayed. Specifically, as shown in FIG. 13, a phrase “Will you join up with this session?”, an indication 280 of the normal name of the session creator (host player), a button 281 with an indication “set other name”, a button 282 with an indication “join up”, and a button 283 with an indication “not join up”, are displayed. As described above, the normal name is displayed instead of the other name of the host player, so that the player can easily find who the host player is.

In a case of displaying a normal name for a private battle (including during a battle), an ID number (e.g., #1234) of the player may be additionally displayed on a side of the normal name. Thus, it becomes easy to distinguish whether the displayed name is another name or a normal name.

When the player operates the cursor 200 and has selected and pressed the button 281 with an indication “set other name”, a screen (not shown) on which the player can set another name as in the case of the button 270 in FIG. 12 is displayed. When the player operates the cursor 200 and has selected and pressed the button 282 with an indication “join up”, the player is to join up to participate in the session for the private battle created by the other player who is a friend directly or indirectly. When the player operates the cursor 200 and has selected and pressed the button 283 with an indication “not join up”, the player does not join up with the session for the private battle and the screen returns to the screen shown in FIG. 11.

FIG. 14 shows a screen displayed when the button 271 with an indication “create” in FIG. 12 or the button 282 with an indication “join up” in FIG. 13 is pressed. When the button 271 with an indication “create” in FIG. 12 is pressed, a session for a private battle is created and displayed, and then members satisfying the participation condition for the private battle are sequentially additionally displayed as shown in FIG. 14. When the button 282 with an indication “join up” in FIG. 13 is pressed, a session for a private battle that has already been created is displayed and then members satisfying the participation condition for the private battle are sequentially additionally displayed as shown in FIG. 14.

Here, the participation condition for the private battle is that the player is a host player, the player is friends with a host player, or the player is friends with another player (a player other than a host player) who participates in the session for the private battle. That is, the participation condition is that the player is a host player or is directly or indirectly in a friend relationship with a host player.

Thereafter, the host player performs an operation to end invitation of participant members for the private battle. Next, the host player performs an operation to sort the participant members into two teams to compete with each other, and then the host player performs an operation to start the private battle (not shown). Here, in the session for the private battle, two players who can watch the private battle can participate in addition to eight players who can participate in the private battle (i.e., up to ten players can participate). The private battle can be executed if two or more players have participated. When two or more players have participated in the session for the private battle, the host player can end invitation of participant members and start the private battle.

On the screen (see FIG. 14) displaying the participant members for the private battle, at indications of the participant members, other names are indicated on the players for which the other names have been set, and normal names are indicated on the players for which other names have not been set.

FIG. 15 shows an example of a screen of a private battle. As shown in FIG. 15, in a virtual space in which the private battle is executed, characters of players who have participated in the session are displayed, and above an ally character, a normal name or another name of a player who operates the ally character is displayed. That is, another name is displayed for an ally character of a player for which the other name has been set, and a normal name is displayed for a character of an ally player for which another name has not been set. In the example shown in FIG. 15, an own character 235, an ally character 236, and an enemy character 237 are displayed, and another name ‘BBBB’ of a player who operates the ally character 236 is displayed above the ally character 236. A name (normal name or other name) may be displayed also for the enemy character, and a name (normal name or other name) may be displayed also for the own character. In a case of displaying a normal name in the private battle, an ID number (e.g., #1234) of the player may be additionally displayed on a side of the normal name. In addition, a normal name and another name may be displayed in different colors, or a predetermined sign or the like may be displayed for them. Thus, it becomes easy to distinguish whether the name is another name or a normal name Here, in the exemplary embodiment, for convenience of description, normal names are written by lowercase letters and other names are written by uppercase letters, as described above. However, in actuality, players can use arbitrary letters (various letters including lowercase letters and uppercase letters) for normal names and other names.

Regarding the private battle, in various scenes where player's names are displayed, if another name has been set, the other name is displayed instead of a normal name (not shown). For example, regarding the description “enemy xxx defeated” indicating that an enemy character is defeated, a part “xxx” is displayed by another name instead of a normal name. In addition, for example, regarding the description “ally yyy defeated” indicating that an ally character is defeated, a part “yyy” is displayed by another name instead of a normal name. Further, for example, regarding the description “defeated by zzz” indicating that the own character is defeated and indicating a player who has defeated the own character, a part “zzz” is displayed by another name instead of a normal name. Moreover, for example, at the time of indicating that the ally team has won the battle, a player's name part of a name plate indicated near the own character is displayed by another name instead of a normal name. In this game, record movies of a normal battle and a private battle can be recorded automatically or by a player's operation, and can be reproduced by a player's operation. When the record movie is reproduced, names (other names or normal names) used at the time of the battle are displayed. Here, the name of a recording person (the name of the player who recorded the record movie) is additionally displayed during reproduction of the record movie. The name of the recording person is displayed with an ID number added to an indication of a normal name. The player can report a name (another name or a normal name of another player) considered inappropriate, and also on a screen for reporting such another name, another name is displayed.

[Details of Information Processing in Exemplary Embodiment]

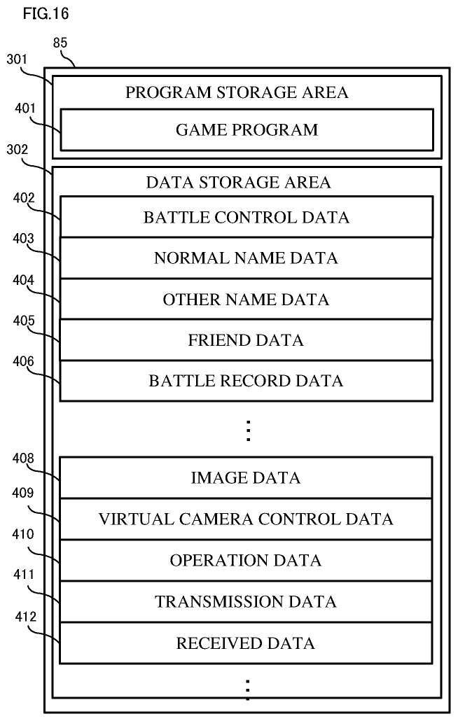

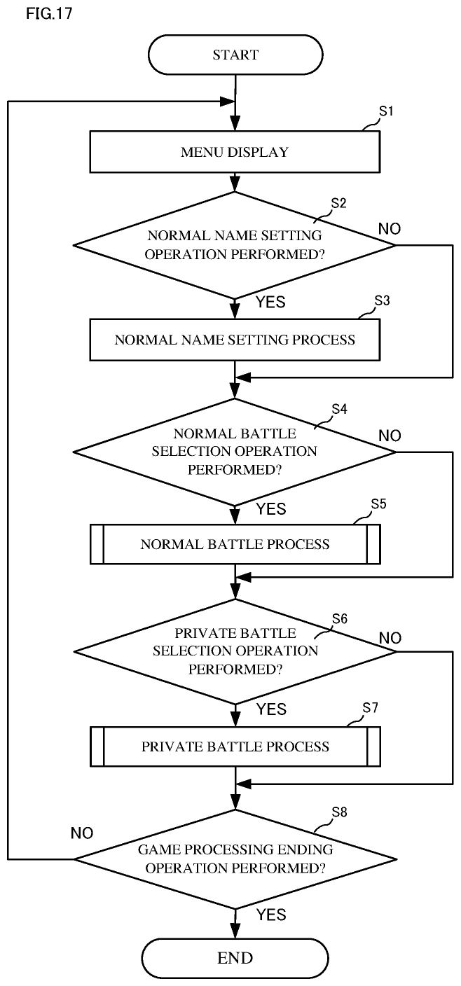

Next, with reference to FIG. 16 to FIG. 21, the information processing in the exemplary embodiment will be described in detail.

[Used Data]

Various data used in the game processing will be described. FIG. 16 shows an example of data stored in the DRAM 85 of the game apparatus 1. As shown in FIG. 16, in the DRAM 85, at least a program storage area 301 and a data storage area 302 are provided. In the program storage area 301, a game program 401 is stored. In the data storage area 302, battle control data 402, normal name data 403, other name data 404, friend data 405, battle record data 406, image data 408, virtual camera control data 409, operation data 410, transmission data 411, received data 412, and the like, are stored.

The game program 401 is a game program for executing the game processing.

The battle control data 402 is data for performing a normal battle and a private battle. The battle control data 402 includes various data for controlling operations of characters in a battle, e.g., positions, orientations, and operation states of characters, data of items with which characters are equipped, and the like.

The normal name data 403 is data of normal names set by players. The normal name data 403 includes data of the normal name of the player him/herself, and data of normal names of players who have participated in a session for a normal battle or a private battle (see FIG. 9 and FIG. 14).

The other name data 404 is data of other names set by players. The other name data 404 includes data of the other name of the player him/herself, and data of other names of players who have participated in a session for a private battle (see FIG. 14).

The friend data 405 is data about friends of the player. In addition, the friend data 405 includes ID numbers and names (normal names/other names) of players (accounts) who participate in a normal battle or a private battle.

The battle record data 406 is record data of normal battles and private battles. The battle record data 406 includes record data of participant members, wins/losses, and the like in normal battles and private battles, recorded data of game movies of normal battles and private battles, and the like. In addition, the names (other names or normal names) of players displayed when battles were performed are stored in association with the record data of participant members, wins/losses, and the like, the recorded data of game movies, and the like described above. Thus, names of players used when a battle was performed are displayed when the player watches the record data of participant members, wins/losses, and the like, the recorded data of game movies, and the like described above.

The image data 408 is image data of characters, items, backgrounds, and the like.

The virtual camera control data 409 is data for controlling movement of a virtual camera placed in a virtual space. Specifically, the virtual camera control data 409 is data specifying the position, the orientation, the angle of view, the capturing direction, and the like of a virtual camera.

The operation data 410 is data indicating the content of an operation performed on the left controller 3 and the right controller 4. For example, the operation data 410 includes data indicating input states with respect to movements and orientation changes of the left controller 3 and the right controller 4, the press states of various buttons thereof, and the like. The content of the operation data 410 is updated per predetermined cycle, on the basis of signals from the left controller 3 and the right controller 4.

The transmission data 411 is data to be transmitted to another game apparatus 1, and at least includes information for identifying the transmission source and the content of the operation data 410.

The received data 412 is transmission data received from another game apparatus 1 and stored in such a manner that the data can be identified for each of other game apparatuses 1 (i.e., each transmission source can be recognized).

Besides, various data to be used in the game processing are stored in the DRAM 85, as necessary.

[Details of Game Processing]

Next, with reference to flowcharts, the details of the game processing according to the exemplary embodiment will be described. FIG. 17 to FIG. 21 are examples of flowcharts showing the details of the game processing according to the exemplary embodiment.

First, when the application of this game is started and the game processing is started, in step S1 in FIG. 17, the processor 81 performs menu display (see FIG. 8). Then, the process proceeds to step S2.

In step S2, the processor 81 determines whether or not a normal name setting operation has been performed. Specifically, as described with reference to FIG. 8, the processor 81 determines whether or not the menu 210 for setting a normal name has been executed. If the determination result is YES, the process proceeds to step S3, and if the determination result is NO, the process proceeds to step S4.

In step S3, the processor 81 performs a normal name setting process. Specifically, as described with reference to FIG. 8, the processor 81 sets a normal name for the player in accordance with an input operation by the player, and stores the normal name in the normal name data 403. Then, the process proceeds to step S4. In step S3, the processor 81 restricts execution of processing for changing (resetting) the normal name in a predetermined period (e.g., 30 days), and performs control so that the player cannot change (reset) the normal name in the predetermined period. Thus, other players can be prevented from being confused by change of a normal name (typically, a normal name displayed as the host player; see FIG. 13) in a short period. Then, the process proceeds to step S4.

In step S4, the processor 81 determines whether or not a normal battle selection operation has been performed. Specifically, as described with reference to FIG. 8, the processor 81 determines whether or not the menu 211 for selecting a normal battle has been executed. If the determination result is YES, the process proceeds to step S5, and if the determination result is NO, the process proceeds to step S6.

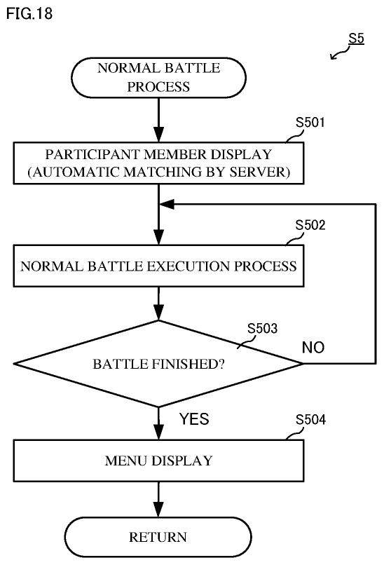

In step S5, the processor 81 performs a normal battle process. FIG. 18 is an example of a flowchart showing the normal battle process.

In step S501 in FIG. 18, the processor 81 performs participant member display for a normal battle, on the basis of the normal name data 403. Specifically, as described with reference to FIG. 9, the processor 81 displays eight players (players for which the normal names are displayed) representing participant members for the normal battle who are automatically sorted (matched) by the server connected to each game apparatus 1 via the network. Hereinafter, this processing will be described more specifically.

From the game apparatus 1 on which a normal battle selection operation has been performed (see step S4 in FIG. 17), participation request data indicating a participation request for the normal battle (e.g., data including the normal name and the ID number of the player) is transmitted to the server. When the server has received the participation request data from each game apparatus 1, the server sequentially sorts players into the created session for the normal battle in accordance with the levels of characters of the players who have made participation requests, and the like, and sequentially transmits identification data (e.g., normal names and ID numbers) of the sorted players to each game apparatus 1. The game apparatus 1 (processor 81) stores the identification data sequentially received from the server, into the normal name data 403, and on the basis of the normal name data 403, displays the session for the normal battle in which the normal name of the own player (and, if there has already been a participant member, the normal name of the participant member) is displayed. In a case where the number of participant members has not reached the upper limit number “8” yet, the game apparatus 1 (processor 81) sequentially additionally displays another participant member for which the normal name is displayed. Then, when the number of participant members has reached eight, the game apparatus 1 (processor 81) displays eight players (normal names) representing all the participant members for the normal battle who have been automatically sorted by the server, as shown in FIG. 9. In the above description, the normal names are transmitted and received between the game apparatuses 1 via the server, but the normal names may be directly transmitted and received between the game apparatuses 1. In this case, at the timing of participating in the session, the game apparatus 1 directly transmits and receives data including normal names to and from the game apparatus 1 (player) that has already participated in the session. In addition, the game apparatus 1 directly transmits and receives data including normal names to and from another game apparatus 1 that participates in the session later, at the timing when the other game apparatus 1 participates in the session later. In a case of participating in the normal battle (session for normal battle) for the first time, the names (normal names) of participant members may not be displayed until the normal battle is started. In a case of consecutively performing the normal battle while remaining participating in the same session, names (normal names) may be displayed only for members who participate in the session consecutively. Then, the process proceeds to step S502.

In step S502, the processor 81 performs a normal battle execution process on the basis of the battle control data 402. Specifically, as described with reference to FIG. 10, the processor 81 executes a competitive game with characters of the players who have participated in the session, in a virtual space. In addition, as described with reference to FIG. 10, the processor 81 displays, above the ally character, the normal name of the player who operates the ally character. Then, the process proceeds to step S503.

In step S503, the processor 81 determines whether or not the normal battle has finished, on the basis of the battle control data 402. Specifically, the processor 81 determines whether or not a normal battle finish condition that, e.g., a predetermined battle execution time has ended or one team has won, is satisfied. If the determination result is NO, the process returns to step S502 to continue the normal battle, and if the determination result is YES, the process proceeds to step S504.

In step S504, the processor 81 performs menu display (see FIG. 8). Then, the process proceeds to step S6 in FIG. 17.

In step S6 in FIG. 17, the processor 81 determines whether or not a private battle selection operation has been performed. Specifically, as described with reference to FIG. 8, the processor 81 determines whether or not the menu 212 for selecting a private battle has been executed. If the determination result is YES, the process proceeds to step S7, and if the determination result is NO, the process proceeds to step S8.

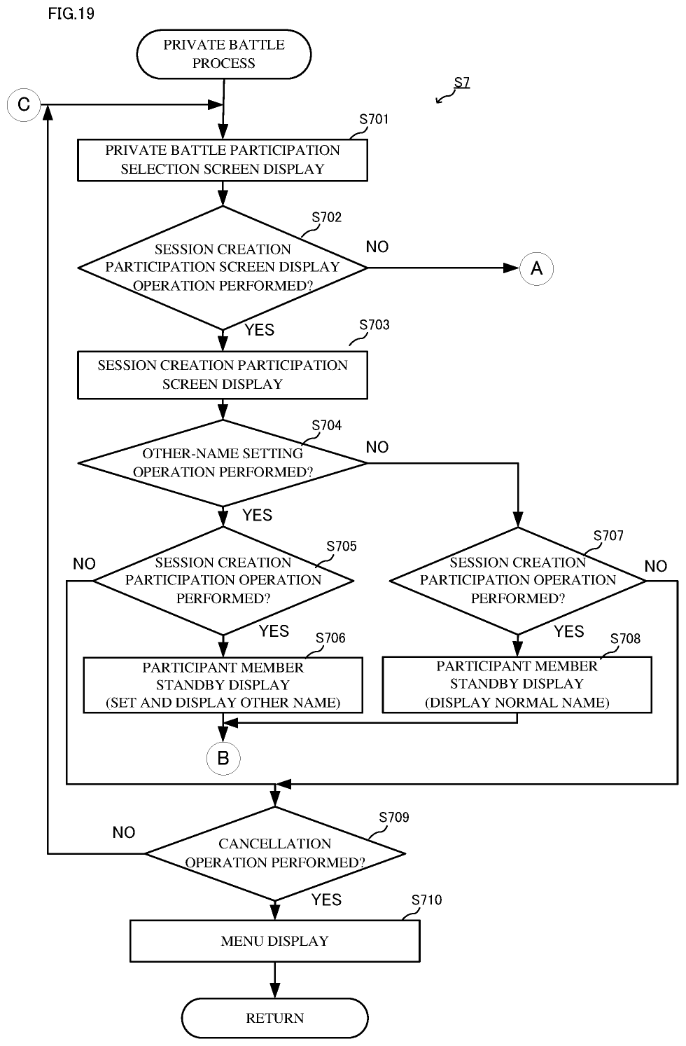

In step S7, the processor 81 performs a private battle process. FIG. 19 is an example of a flowchart showing the private battle process.

In step S701 in FIG. 19, the processor 81 performs private battle participation selection screen display. Specifically, as described with reference to FIG. 11, the processor 81 displays a screen for participating in a private battle (creating a private battle and participating therein, or joining up to participate in a private battle), on which a friend list (normal names are displayed) is displayed, using the friend data 405 and the normal name data 403. Then, the process proceeds to step S702.

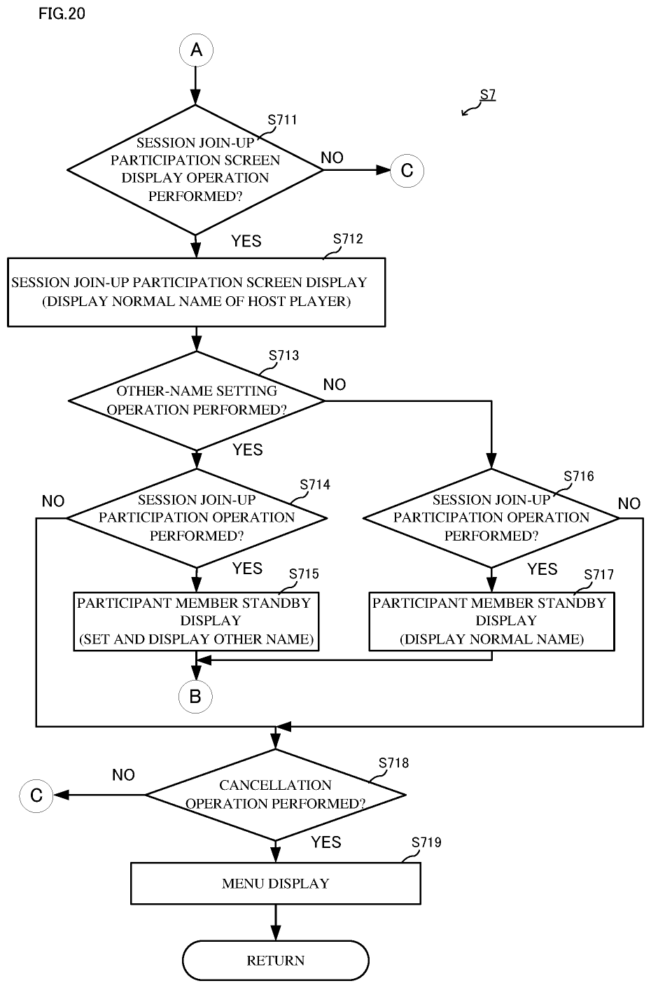

In step S702, the processor 81 determines whether or not a session creation participation screen display operation has been performed. Specifically, the processor 81 determines whether or not an operation of executing the menu 250 with an indication “create session” in FIG. 11 has been performed. If the determination result is YES, the process proceeds to step S703, and if the determination result is NO, the process proceeds to step S711 in FIG. 20.

In step S703, the processor 81 performs session creation participation screen display. Specifically, the processor 81 displays the screen shown in FIG. 12. Then, the process proceeds to step S704.

In step S704, the processor 81 determines whether or not an other-name setting operation has been performed. Specifically, as described with reference to FIG. 12, the processor 81 determines whether or not an operation of executing the menu 270 with an indication “set other name” has been performed. If the determination result is YES, the process proceeds to step S705, and if the determination result is NO, the process proceeds to step S707.

In step S705, the processor 81 determines whether or not a session creation participation operation has been performed. Specifically, as described with reference to FIG. 12, the processor 81 determines whether or not an operation of executing the menu 271 with an indication “create” has been performed. If the determination result is YES, the process proceeds to step S706, and if the determination result is NO, the process proceeds to step S709.

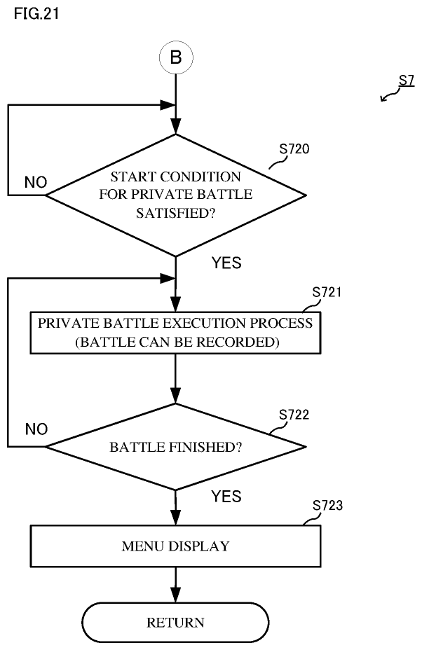

In step S706, the processor 81 creates a session for a private battle and performs participant member standby display, using the normal name data 403 and the other name data 404. Specifically, as described with reference to FIG. 14, the processor 81 performs participant member standby display to sequentially additionally display members satisfying the participation condition for the private battle. As described with reference to FIG. 14, the participation condition for the private battle is that the player is a host player, the player is friends with a host player, or the player is friends with another player (a player other than a host player) who participates in the session for the private battle. In addition, the processor 81 sets the other name (the other name of the player who has performed the other-name setting operation) in accordance with the other-name setting operation, and displays the set other name on the participant member standby screen for the private battle (see FIG. 14). In addition, the processor 81 acquires the name (normal name or other name) of another participant member by communicating with another game apparatus 1 via the server or directly, and displays the acquired name on the participant member standby screen (see FIG. 14). Specifically, in a case where another participant member has set another name, the processor 81 acquires the other name by communicating with the other game apparatus 1, and displays the acquired other name on the participant member standby screen, and in a case where another participant member has not set another name, the processor 81 acquires the normal name of the other participant member by communicating with the other game apparatus 1, and displays the acquired normal name on the participant member standby screen. In a case where another participant member has set another name, the processor 81 may acquire both of the other name and the normal name by communicating with the other game apparatus 1. In addition, the processor 81 transmits the name (normal name or other name) of the own player to another game apparatus 1 via the server or directly. Thus, the name (normal name or other name) of the own player can be displayed on the other game apparatus 1. Then, the process proceeds to step S720 in FIG. 21.

In step S707, the processor 81 determines whether or not a session creation participation operation has been performed, as in step S705. If the determination result is YES, the process proceeds to step S708, and if the determination result is NO, the process proceeds to step S709.

In step S708, the processor 81 performs participant member standby display for a private battle, as in step S706. Here, since the player has not performed an other-name setting operation, the processor 81 does not set another name and displays the normal name (the normal name of the player who has not performed other-name setting operation) on the participant member standby screen for the private battle (see FIG. 14). Then, the process proceeds to step S720 in FIG. 21.

In step S709, the processor 81 determines whether or not a cancellation operation to the effect that the player does not perform session creation participation has been performed. Specifically, as described with reference to FIG. 12, the processor 81 determines whether or not an operation of executing the menu 272 with an indication “not create” has been performed. If the determination result is YES, the process proceeds to step S710, and if the determination result is NO, the process returns to step S701.

In step S710, the processor 81 performs menu display (see FIG. 8). Then, the process proceeds to step S8 in FIG. 17.

In step S711 in FIG. 20, the processor 81 determines whether or not a session join-up participation screen display operation has been performed. Specifically, the processor 81 determines whether or not an operation of executing processing for the friend (261, 263) with an indication [can be joined] on the friend list in FIG. 11 has been performed. If the determination result is YES, the process proceeds to step S712, and if the determination result is NO, the process returns to step S701 in FIG. 19.

In step S712, the processor 81 performs session join-up participation screen display. Specifically, the processor 81 performs session join-up participation screen display shown in FIG. 13, and at this time, receives data indicating the normal name of the host player from the game apparatus 1 of the host player (or from the server) and displays the normal name of the host player (see 280 in FIG. 13). Then, the process proceeds to step S713.

In step S713, the processor 81 determines whether or not an other-name setting operation has been performed. Specifically, as described with reference to FIG. 13, the processor 81 determines whether or not an operation of executing the menu 281 with an indication “set other name” has been performed. If the determination result is YES, the process proceeds to step S714, and if the determination result is NO, the process proceeds to step S716.

In step S714, the processor 81 determines whether a session join-up participation operation has been performed. Specifically, as described with reference to FIG. 13, the processor 81 determines whether or not an operation of pressing the button 282 with an indication “join up” has been performed. If the determination result is YES, the process proceeds to step S715, and if the determination result is NO, the process proceeds to step S718.

In step S715, the processor 81 performs participant member standby display of the session for the private battle, using the normal name data 403 and the other name data 404. Specifically, as described with reference to FIG. 14, the processor 81 performs participant member standby display to sequentially additionally display members satisfying the above participation condition for the private battle. In addition, the processor 81 sets the other name (the other name of the player who has performed the other-name setting operation) in accordance with the other-name setting operation, and displays the set other name on the participant member standby screen for the private battle (see FIG. 14). In addition, the processor 81 acquires the name (normal name or other name) of another participant member by communicating with another game apparatus 1 via the server or directly, and displays the acquired name on the participant member standby screen (see FIG. 14). Specifically, in a case where another participant member has set another name, the processor 81 acquires another name by communicating with the other game apparatus 1, and displays the acquired other name on the participant member standby screen, and in a case where another participant member has not set another name, the processor 81 acquires the normal name of the other participant member by communicating with the other game apparatus 1, and displays the acquired normal name on the participant member standby screen. In a case where another participant member has set another name, the processor 81 may acquire both of the other name and the normal name by communicating with the other game apparatus 1. In addition, the processor 81 transmits the name (normal name or other name) of the own player to another game apparatus 1 via the server or directly. Thus, the name (normal name or other name) of the own player can be displayed on the other game apparatus 1. Then, the process proceeds to step S720 in FIG. 21.

In step S716, the processor 81 determines whether or not a session join-up participation operation has been performed, as in step S714. If the determination result is YES, the process proceeds to step S717, and if the determination result is NO, the process proceeds to step S718.

In step S717, the processor 81 performs participant member standby display for the private battle, as in step S715. Here, since the player has not performed an other-name setting operation, the processor 81 does not set another name and displays the normal name (the normal name of the player who has not performed the other-name setting operation) on the participant member standby screen for the private battle (see FIG. 14). Then, the process proceeds to step S720 in FIG. 21.

In step S718, the processor 81 determines whether or not a cancellation operation to the effect that the player does not join up to participate in the session has been performed. Specifically, as described with reference to FIG. 13, the processor 81 determines whether or not an operation of pressing the button 283 with an indication “not join up” has been performed. If the determination result is YES, the process proceeds to step S719, and if the determination result is NO, the process returns to step S701 in FIG. 19.

In step S719, the processor 81 performs menu display (see FIG. 8). Then, the process proceeds to step S8 in FIG. 17.

In step S720 in FIG. 21, the processor 81 determines whether or not a start condition for the private battle is satisfied. Specifically, as described with reference to FIG. 14, the processor 81 determines whether or not the host player has performed an operation of performing team sorting and the like and starting the private battle. Until the determination result becomes YES, the process waits (NO), and when the determination result becomes YES, the process proceeds to step S721.

In step S721, the processor 81 performs a private battle execution process, using the battle control data 402. Specifically, the processor 81 executes the private battle by operating each character in accordance with an operation by a participant member in the battle (see FIG. 15). In addition, as described with reference to FIG. 15, in the private battle, the processor 81 displays the normal name or the other name of the player who operates the ally character, for example, above the ally character, using the normal name data 403 and the other name data 404. In addition, automatically or in accordance with an operation by the player, the processor 81 makes a record movie of the private battle and records the movie in the battle record data 406. At this time, the processor 81 records the participant players (ID numbers) and the other names or the normal names of those players used when they participated in the battle, in association with the record movie, in the battle record data 406. Then, at the time of reproducing and displaying the record movie in accordance with a player's operation, the processor 81 displays the other names or the normal names of the ally players used when they participated in the private battle. Thus, when the record movie is reproduced, the names (other names or normal names) used when the private battle was executed are displayed. Then, the process proceeds to step S722.

In step S722, the processor 81 determines whether or not the private battle has finished, on the basis of the battle control data 402. Specifically, the processor 81 determines whether or not a private battle finish condition that, e.g., a predetermined battle execution time has ended or one team has won, is satisfied. If the determination result is NO, the process returns to step S721 to continue the private battle, and if the determination result is YES, the process proceeds to step S723.

In step S723, the processor 81 performs menu display (see FIG. 8). Then, the process proceeds to step S8 in FIG. 17.

In step S8 in FIG. 17, the processor 81 determines whether or not an operation of ending the game processing of this game (an operation of ending the application of this game) has been performed. If the determination result is YES, the game processing of this game ends, and if the determination result is NO, the process returns to step S1.

As described above, according to the exemplary embodiment, it is possible to set different names between a normal battle in which participant members are automatically determined by the server and a private battle which is performed by participant members who are directly or indirectly in a friend relationship. In addition, in the private battle which is performed by participant members who are directly or indirectly in a friend relationship, a name (other name) that cannot be set in the normal battle for which the player does not know who will participate, can be set, to boost the battle mood. For example, in a case of performing a private battle in a community formed by private friends, co-workers, or the like, other names used in the community or other names that will boost the mood in the community can be set, to boost the battle mood. As described above, according to the exemplary embodiment, it is possible to boost the battle mood by setting other names in accordance with members (players) who participate in the battle, as appropriate.

[Modifications]

In the above exemplary embodiment, the participation condition for a private battle is that the player is a host player or is directly or indirectly in a friend relationship with a host player. However, for example, the participation condition for a private battle may be that the player is in a friend relationship with all the players (the host player and the other players) who have participated in the session for the private battle. Alternatively, the participation condition for a private battle may be that the player inputs a predetermined password determined by a host player or the like, or may be that the player uses a two-dimensional code or the like provided from a host player or the like. A condition that the player has a relationship of following another player or being followed by another player may be used instead of a friend relationship. A host player may set (select) a participation condition for a private battle, for example.

In the above exemplary embodiment, the case where the player inputs and sets the normal name on the menu display has been shown (see FIG. 8). However, for example, the player may not be allowed to set the normal name, and a name allocated to the game apparatus 1 in advance may be set as the normal name. Alternatively, for example, an ID number (e.g., #1234) allocated to the player (player's account) may be set as the normal name. Still alternatively, for example, a name obtained by adding a random four-digit number to the name of a character (e.g., CAT0001) or a name obtained by adding a random four-digit number to letters “player” (e.g., player 0001) may be automatically allocated as the normal name. Thus, such a name that has no element indicating a player, a game apparatus, or the like may be set.

In the above exemplary embodiment, creation and management of sessions for a normal battle and a private battle may be executed by the game apparatus 1 of a host player or may be executed by the server.

In the above exemplary embodiment, normal names, other names, and the like are presented to the player by being displayed on a screen. However, they may be presented to the player by a sound or the like as necessary.

In the above exemplary embodiment, the player who participates in a private battle (typically, a host player) may be allowed to set the content of the private battle, at the time of participating in the private battle. For example, when creating and participating in a private battle, the host player may be allowed to set a competition rule, the number of competition players, team sorting, and the like for the private battle.

In the above exemplary embodiment, at the time of joining up to participate in a private battle, the normal name of the host player is displayed (see FIG. 13). However, at the time of joining up to participate in a private battle, the normal names of other players who participate in the session for the private battle may be displayed in addition to the normal name of the host player.

In the above exemplary embodiment, the case where the sequential processing in the game processing is executed by a single game apparatus (main body apparatus) 1 has been described. In another exemplary embodiment, the sequential processing may be executed in an information processing system including a plurality of information processing apparatuses. For example, in an information processing system including a terminal-side apparatus and a server-side apparatus that can communicate with the terminal-side apparatus via a network, a part of the sequential processing may be executed by the server-side apparatus. In an information processing system including a terminal-side apparatus and a server-side apparatus that can communicate with the terminal-side apparatus via a network, a major part of the sequential processing may be executed by the server-side apparatus and a part of the sequential processing may be executed by the terminal-side apparatus. In the information processing system, a server-side system may include a plurality of information processing apparatuses and processing to be executed on the server side may be executed by the plurality of information processing apparatuses in a shared manner. A configuration of so-called cloud gaming may be adopted. For example, the game apparatus (main body apparatus) 1 may transmit operation data indicating a user's operation to a predetermined server, various game processing may be executed on the server, and the execution result may be distributed as a video and a sound by streaming to the game apparatus (main body apparatus) 1.

While the exemplary embodiments have been described herein, it is to be understood that the above description is, in all aspects, merely an illustrative example, and is not intended to limit the scope thereof. It is to be understood that various modifications and variations can be made without deviating from the scope of the exemplary embodiments.

1. One or more non-transitory computer-readable storage media having stored therein instructions that, when executed by one or more processors, perform operations comprising:
setting a first name in association with a player using an information processing apparatus connectable to a network and a plurality of other information processing apparatuses operated by respective other players;
causing the player to participate in a first session on the basis of a first operation by the player, without letting the player select a session to participate in;
when the player is going to participate in the first session, transmitting first data including the first name to be presented as a name of the player, so that the first data is receivable by each other information processing apparatus that is participating in the first session, and executing a first game among the players participating in the first session;
causing the player to participate in a second session on the basis of a second operation by the player different from the first operation;
before causing the player to participate in the second session, accepting an input of a second name from the player, and when the second name is inputted, setting the second name in association with the player; and
when the player is going to participate in the second session, transmitting second data including the first name or the second name to be presented as a name of the player, so that the second data is receivable by each other information processing apparatus that is participating in the second session, and executing a second game among the players participating in the second session.

2. The one or more non-transitory computer-readable storage media according to claim 1, wherein:
the second operation includes a third operation of creating the second session, and
the instructions, when executed, further create the second session after making a setting so as to allow only the player satisfying a predetermined condition to participate in the second session on the basis of the third operation.

3. The one or more non-transitory computer-readable storage media according to claim 2, wherein the predetermined condition is a condition of being the player who has created the second session or the player who is in a friend relationship with the player who is going to participate in the second session.

4. The one or more non-transitory computer-readable storage media according to claim 3, wherein:
the second operation includes a fourth operation of participating in the second session created by each of the other players, and
the instructions, when executed, further present at least one of the first names associated with the players who are going to participate in the second session before causing the player to participate in the second session on the basis of the fourth operation.

5. The one or more non-transitory computer-readable storage media according to claim 4, wherein the instructions, when executed, further restrict change of the first name in a predetermined period after the first name has been set for the player.

6. The one or more non-transitory computer-readable storage media according to claim 1, wherein the instructions, when executed, further present the first name or the second name of each player who has participated in the second session, and make a name presentation manner in which the first name is presented and a name presentation manner in which the second name is presented, different from each other.

7. The one or more non-transitory computer-readable storage media according to claim 1, wherein the instructions, when executed, further set the second name at a timing when the second operation is performed.

8. The one or more non-transitory computer-readable storage media according to claim 1, wherein the instructions, when executed, further record the players who have participated in the second session, and store the first name or the second name presented during execution of the second session, in association with each player who has participated in the second session.

9. An information processing system of a player, connectable to a network and a plurality of other information processing systems operated by respective other players, the information processing system comprising:
one or more memories coupled to one or more processors configured to control the information processing system to perform operations comprising:
setting a first name in association with the player;
causing the player to participate in a first session on the basis of a first operation by the player, without letting the player select a session to participate in;
when the player is going to participate in the first session, transmitting first data including the first name to be presented as a name of the player, so that the first data is receivable by each other information processing system that is participating in the first session, and executing a first game among the players participating in the first session;
causing the player to participate in a second session on the basis of a second operation by the player different from the first operation;
before causing the player to participate in the second session, accepting an input of a second name from the player, and when the second name is inputted, setting the second name in association with the player; and
when the player is going to participate in the second session, transmitting second data including the first name or the second name to be presented as a name of the player, so that the second data is receivable by each other information processing system that is participating in the second session, and executing a second game among the players participating in the second session.

10. An information processing apparatus of a player, connectable to a network and a plurality of other information processing apparatuses operated by respective other players, the information processing apparatus comprising:
one or more memories coupled to one or more processors configured to control the information processing apparatus to perform operations comprising:
setting a first name in association with the player;
causing the player to participate in a first session on the basis of a first operation by the player, without letting the player select a session to participate in;
when the player is going to participate in the first session, transmitting first data including the first name to be presented as a name of the player, so that the first data is receivable by each other information processing apparatus that is participating in the first session, and executing a first game among the players participating in the first session;
causing the player to participate in a second session on the basis of a second operation by the player different from the first operation;
before causing the player to participate in the second session, accepting an input of a second name from the player, and when the second name is inputted, setting the second name in association with the player; and
when the player is going to participate in the second session, transmitting second data including the first name or the second name to be presented as a name of the player, so that the second data is receivable by each other information processing apparatus that is participating in the second session, and executing a second game among the players participating in the second session.

11. An information processing method executed in connection with an information processing system of a player, the information processing system being connectable to a network and a plurality of other information processing systems operated by respective other players, the information processing method comprising:
setting a first name in association with the player;
causing the player to participate in a first session on the basis of a first operation by the player, without letting the player select a session to participate in;
when the player is going to participate in the first session, transmitting first data including the first name to be presented as a name of the player, so that the first data is receivable by each other information processing system that is participating in the first session, and executing a first game among the players participating in the first session;
causing the player to participate in a second session on the basis of a second operation by the player different from the first operation;
before causing the player to participate in the second session, accepting an input of a second name from the player, and when the second name is inputted, setting the second name in association with the player; and
when the player is going to participate in the second session, transmitting second data including the first name or the second name to be presented as a name of the player, so that the second data is receivable by each other information processing system that is participating in the second session, and executing a second game among the players participating in the second session.

12. The information processing system according to claim 9, wherein:
the second operation includes a third operation of creating the second session, and
the second session is created after making a setting so as to allow only the player satisfying a predetermined condition to participate in the second session on the basis of the third operation.

13. The information processing system according to claim 12, wherein the predetermined condition is a condition of being the player who has created the second session or the player who is in a friend relationship with the player who is going to participate in the second session.

14. The information processing system according to claim 13, wherein:
the second operation includes a fourth operation of participating in the second session created by each of the other players, and
at least one of the first names associated with the players who are going to participate in the second session is presented before causing the player to participate in the second session on the basis of the fourth operation.

15. The information processing system according to claim 14, wherein changing of the first name is restricted in a predetermined period after the first name has been set for the player.

16. The information processing method according to claim 11, wherein the second operation includes a third operation of creating the second session, the method further comprising creating the second session after making a setting so as to allow only the player satisfying a predetermined condition to participate in the second session on the basis of the third operation.

17. The information processing method according to claim 16, wherein the predetermined condition is a condition of being the player who has created the second session or the player who is in a friend relationship with the player who is going to participate in the second session.

18. The information processing method according to claim 17, wherein the second operation includes a fourth operation of participating in the second session created by each of the other players, the method further comprising presenting at least one of the first names associated with the players who are going to participate in the second session before causing the player to participate in the second session on the basis of the fourth operation.

19. The information processing method according to claim 18, the method further comprising restricting change of the first name in a predetermined period after the first name has been set for the player.

20. The information processing method according to claim 11, the method further comprising recording the players who have participated in the second session, and storing the first name or the second name presented during execution of the second session, in association with each player who has participated in the second session.
